(19) United States
(12) Patent Application Publication
(10) Pub. No.: US 2003/0004756 A1
(43) Pub. Date: Jan. 2, 2003

(54) Electronic health consultation method

(76) Inventors: Mikio Okamoto, Saitama (JP); Shigeru Yoshida, Shizuoka (JP); Satoshi Ando, Shizuoka (JP)

Correspondence Address: BIRCH STEWART KOLASCH & BIRCH, PO BOX 747, FALLS CHURCH, VA, 22040-0747, US

(21) Appl. No.: 10/181,383

(22) PCT Filed: Jan. 17, 2001
(86) PCT No.: PCT/JP01/00275

(30) Foreign Application Priority Data
Jan. 17, 2000 (JP) 2000-8311

(51) Int. Cl. G06F 17/60

(52) U.S. Cl. 705/2

(57) ABSTRACT

An electronic health consultation method. Vital data indicative of a health state and photographed images of meals are input by a health advisee's client and saved in a server. A dietician's client views the electronic images of the meals, communicates the results of analysis to the health advisee's client, and stores them in the server. On the health advisee's vital data and the results of analysis of the health advisee's meals carried out by the dietician, the server determines whether or not the health advisee is healthy. If the health advisee is determined to be abnormal, this is communicated to a doctor's client.

### FIELD OF THE INVENTION

The present invention relates to an electronic health consultation method using a communication network such as the Internet to efficiently connect a medical staff and a health advisee together.

### BACKGROUND ART

At present, a medical team (including a medical staff of a doctor, a nurse, a dietician, a sports therapist, and others) treats health advisees who have chronic diseases such as diabetes.

However, to actualize this team health care, the medical staff must be confined to hospitals, thereby requiring a long time and a large amount of expenses. Accordingly, an object of the team health care is to provide excellent team health care for an increasing number of health advisees who have chronic diseases.

At present, if a health advisee visits a hospital and a doctor diagnoses the advisee by checking the advisee's blood sugar level, hemoglobin A1C, and urine, taking an electrocardiogram of the advisee, and carrying out other medical checks, and then determines from the results that the advisee requires health advice, then in the hospital, the medical staff discusses a treatment plan for the health advisee, gives the advisee detailed instructions for chronic diseases such as diabetes, specifically, the conceptual problems of the chronic diseases and practical self-management, and interviews the advisee about once a month to check his progress.

Further, presently, in order to eliminate the need for the health advisee to visit a hospital, the following methods are known by which the advisee can utilize the Internet to consult the doctor.

According to a first method, the health advisee transmits an electronic mail from a personal computer installed in the advisee's home to a personal computer installed in a hospital. The electronic mail describes the contents of health consultation.

According to a second method, the health advisee uses a personal computer in the advisee's home to access home pages that advertise pharmaceutical manufacturers in order to find descriptions relating to the advisee's symptoms.

A problem of the first method is that many health questions can be answered by a dietician instead of a doctor, so that if the doctor must handle a large number of consultations by himself or herself, the doctor does not have much time to execute his or her primary medical operations.

A problem of the second problem is that since the health advisee, who does not have much medical knowledge, must diagnose himself or herself, precise diagnoses are impossible.

### DISCLOSURE OF THE INVENTION

It is thus an object of the present invention to provide a new electronic health consultation method that can provide excellent team health care for an increasing number of health advisees without increasing a burden on the medical staff.

It is another object of the present invention to provide an electronic health consultation server, an electronic health consultation client, and a medical staff client which are suitable for health consultations using the electronic health consultation method.

The present invention provides a health support system comprising clients installed on a health advisee side and on a medical staff side and a server, the clients and the server being connected together via a network, the system comprising the steps of allowing the health advisee to store data about the advisee's health in the server via the advisee's client, storing, in the server, the results of an analysis of the data about the advisee's health stored in the server and allowing the data stored in the server to be shared via the client(s) of the health advisee and/or medical staff.

According to the present invention, the data about the health advisee's health may be data in electronic images of the health advisee's meals. The analysis results may be data about nutritional analysis of the meals obtained by the medical staff by visually checking the electronic image data of the meals. That is, a net dietician system is provided.

According to the present invention, the health advisee can input his or her own nutritional analysis of the electronic images of the meals through the advisee's client. The client can display both nutritional analysis data input by the health advisee and nutritional analysis data input by the medical staff.

According to the present invention, the nutritional analysis data input from the health advisee's client may be transferred to and stored in the server, so that the server automatically compares the nutritional analysis data input by the medical staff 's client and stored in the server with the nutritional analysis data input by the health advisee's client and stored in the server.

According to the present invention, the results of the comparison by the server may be communicated to at least the health advisee's client.

According to the present invention, the electronic images stored in the server and advice on the results of the analysis may be provided by the medical staff 's client directly to the health advisee's client or via the server.

The present invention is characterized in that the health advisee's vital data is input from the advisee's client and transferred to and stored in the server, and the server determines on the basis of a predetermined determination rule whether or not either the transferred vital data or the results of analysis of the meals are indicative of an abnormality of the advisee's health, so that if a result of the determination indicates abnormality, this is communicated to a client of a predetermined related person, the client being connected to the network.

The present invention is characterized in that the settings of the determination rule used by the server can be changed for each health advisee by the medical staff 's client.

According to the present invention, a communication method for notifying the related person's client that an abnormality has been indicated may be chosen from a plurality of predetermined communication methods.

According to the present invention, the readout of the vital data stored in the server may be limited.

According to the present invention, the medical staff includes a doctor and a dietitian, and the health analysis data may be input from each of the doctor's and dietitian's clients.

According to the present invention, the health advisee's client may input a reservation for a health consultation with the medical staff, to the server, and the server may notify the medical staff's client of the input reservation.

According to the present invention, the medical staff's client may notify, via the server, the health advisee's client of health consultation dates and times that are inconvenient to the medical staff.

According to the present invention, advice on the health consultation between the medical staff and the health advisee may be transferred from the medical staff 's client directly to the health advisee's client or via the server.

According to the present invention, the network has a meal delivery service provider's client connected thereto so that the health advisee's or medical staff's client can order a meal or ingredients via the server or the meal delivery service provider's client can deliver a recipe via the server. The delivery of a recipe means that a meal menu suitable for the health advisee is provided.

### BRIEF DESCRIPTION OF THE DRAWINGS

FIG. 1 is a block diagram showing the configuration of an electronic health consultation system according to the present invention.

FIG. 2 is a block diagram showing the configuration of software for server 50.

FIG. 3 is a diagram illustrating the functions of the gateway program.

FIG. 4 is a diagram schematically illustrating a screen displayed on the client.

FIG. 5 is a diagram schematically illustrating a screen displayed on the client.

FIG. 6 is a diagram schematically illustrating a screen displayed on the client.

FIG. 7 is a diagram schematically illustrating a screen displayed on the client.

FIG. 8 is a diagram schematically illustrating a screen displayed on the client.

FIG. 9 is a diagram schematically illustrating a screen displayed on the client.

FIG. 10 is a diagram schematically illustrating a screen displayed on the client.

FIG. 11 is a diagram schematically illustrating a screen displayed on the client.

FIG. 12 is a diagram schematically illustrating a screen displayed on the client.

FIG. 13 is a diagram schematically illustrating a screen displayed on the client.

FIG. 14 is a diagram schematically illustrating a screen displayed on the client.

FIG. 15 is a diagram schematically illustrating a screen displayed on the client.

FIG. 16 is a diagram schematically illustrating a screen displayed on the client.

FIG. 17 is a diagram schematically illustrating a screen displayed on the client.

FIG. 18 is a diagram schematically illustrating a screen displayed on the client.

FIG. 19 is a diagram schematically illustrating a screen displayed on the client.

### BEST MODE FOR CARRYING OUT THE INVENTION

Embodiments of the present invention will be described below with reference to the drawings.

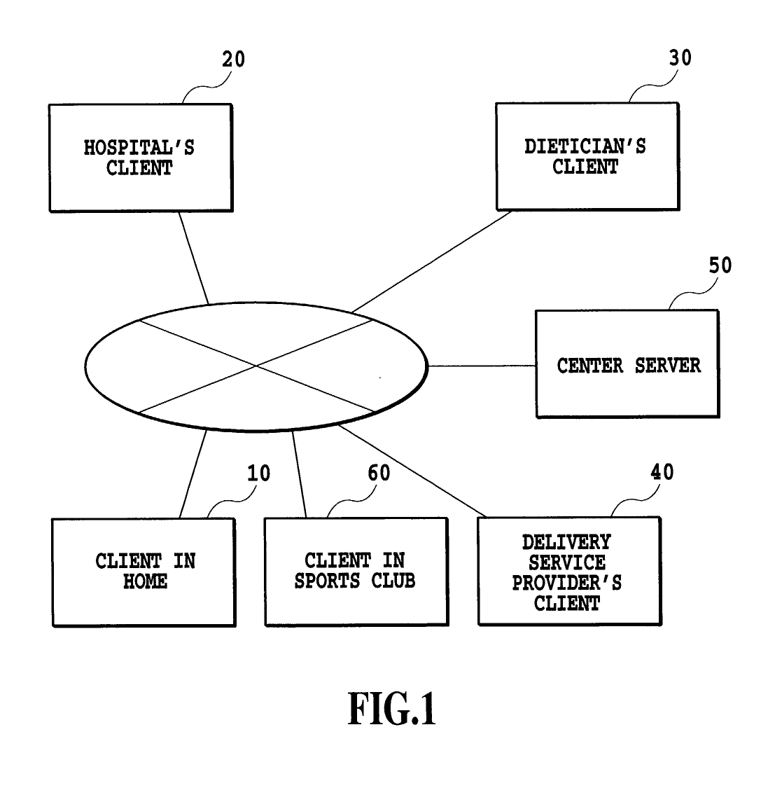

FIG. 1 shows the configuration of a health consultation system to which the present invention has been applied. In FIG. 1, clients 10, 20, 30, 40, and 60 and a server 50 are connected to a communication network such as the Internet.

The clients and server may be commercially available computers having pointing devices such as a keyboard and a mouse as well as communication functions, so that the configuration of the hardware is omitted.

The client 10 is installed in a health advisee's home. Further, the client 10 may also be composed of a PAD (portable digital assistant) or a cellular phone with a camera. The client 20 is used by a doctor and installed in a hospital or home. The client 30 is installed in a dietician's home or company. The client 40 is installed in a meal delivery service provider's office. The server 50 is installed in a computer center. The client 60 is installed in a sports club facility where a sports instructor inputs a training menu for the health advisee.

The clients 10 to 40 and 60 are equipped with a program called a “browser” and used to browse home pages (HTML, XML, or other documents). The clients 10 and 20 are equipped with a program for a video telephone (also referred to as a “video conference”) and have a video camera for a video telephone connected thereto.

The server 50 provides home pages for health consultations. In this embodiment, the health advisee uses the client 10 to access a home page and inputs information about his or her health consultation. The input information includes data indicative of the advisee's health such as photographed images of the foods of the advisee's meals and measurements of the advisee's blood pressure, which data will be described later.

The input information is stored in the server 50 for the advisee. In the server 50, the measurements such as blood pressure are compared with preset permissible values, and if any of the measurements exceeds the corresponding permissible value, the appropriate message is automatically communicated to the hospital client 20 and the advisee's client 10 by electronic mail.

The dietician's client 30 accesses the home page of the center server 50 to visually analyze the meals of the advisee, who receives the dietician's guidance. More specifically, the dietician's client 30 reads out the image file of the photographed meals transmitted by the health advisee and then stored in the server 50 and displays the file. On the basis of this display, the dietician analyzes the contents of the meals and inputs and registers the results of the analysis in the server 50. The registered analysis result is compared with the corresponding permissible value in the server 50, and if it exceeds the permissible value, the appropriate message is automatically communicated to the hospital client 20 and the advisee's client 10 by electronic mail.

Further, the dietician inputs advice on meals to an advice entry section of the home page. The advice is stored in the center server 50 and displayed on the health advisee's client 10 when the advisee accesses the home page of the server 50.

On the client 20, the doctor checks the contents of the electronic mail destined for him or her and then accesses the home page of the center server 50 to enter advice on the advisee's health in the advice entry section. The doctor also enters a message therein as required, indicating that the advisee should visit the hospital. The input advice is stored in the center server 50 and displayed on the health advisee's client 10 when the advisee accesses the home page of the server 50.

The home page of the center server 50 is provided with a page in which set values to be compared with measurements such as blood pressure are provided. On the client 20, the doctor accesses this page to set permissible values for each health advisee.

The health advisee uses the client 10 to access the center server 50 periodically, for example, once a day. During an access, the server 50 checks the advisee against his or her user ID and password, and thus reads out the above described advice information corresponding to the user ID and transfers the information to the health advisee. Thus, the health advisee can view the advice information transmitted by the doctor or dietician.

Subsequently, as described above, the advisee transmits images of the foods of the advisee's meals photographed with a digital camera or the like as well as the advisee's vital data to the server 50.

Furthermore, in this embodiment, a video conference can be implemented between the health advisee's client 10 and the dietician's client 20 and the doctor's client 30. To achieve this, the home page of the center client 50 is provided with a page that allows a video conference to be reserved.

Moreover, in this embodiment, to allow the health advisee to have proper meals according to the doctor or dietician's advice, the home page of the center client 50 is provided with a page that allows the health advisee or medical staff to order certain meals to be delivered to the advisee's home.

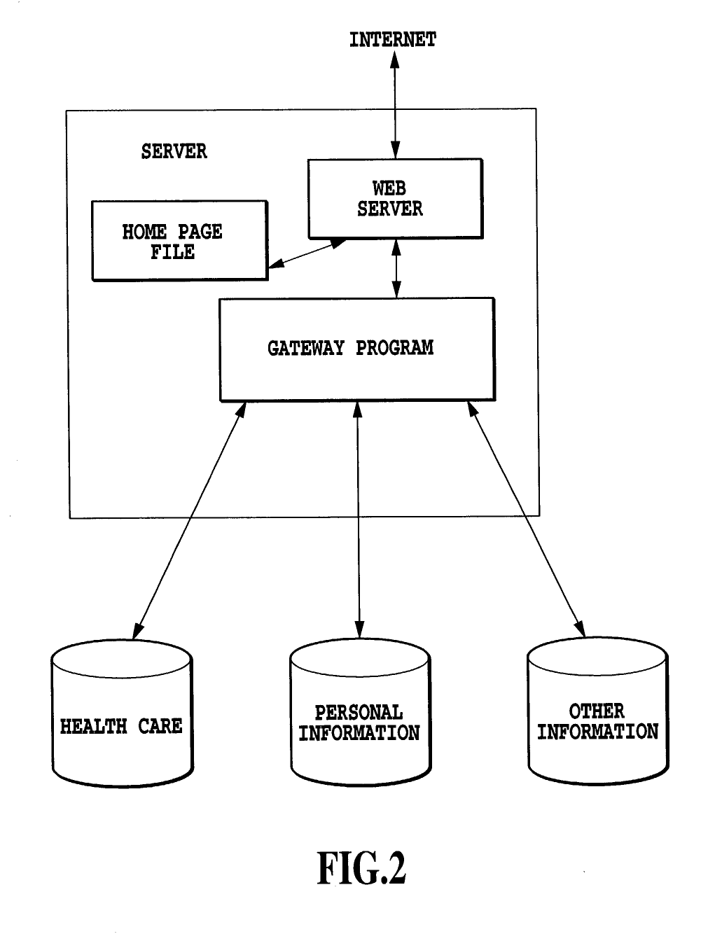

FIG. 2 shows the configuration of software in the server 50 which is required to execute the above described process. The server may be composed of a well-known general-purpose computer, so that a detailed description thereof is omitted.

In FIG. 2, the server 50 has a communication program called a “WEB server” and a gateway program installed therein. The WEB server is such a well-known program that upon receiving an address called a “URL”, more specifically, addressing of an HTML document (or XML document) constituting a home page, from a client's browser, the WEB server reads out the HTML document specified by this address from a group of home page files on an internal hard disk and passes the document out to the browser.

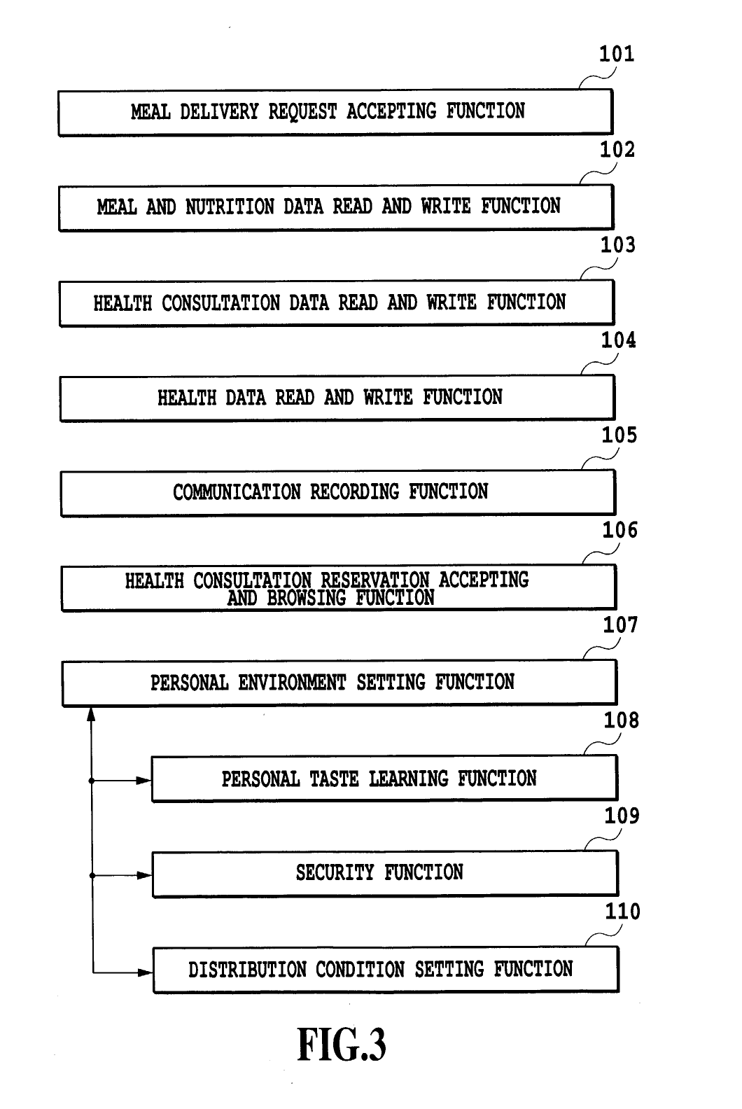

The gateway program is well known and is also called a “gateway interface” which receives a command from a browser via the WEB server for execution. In this embodiment, the gateway program reads data input by a client and writes it to databases, described later, or executes a retrieval process using predetermined keywords. The functions of the gateway program will be described in detail with reference to FIG. 3.

For the server 50, an internally/externally connected storage device has the following databases installed therein.

A health care database stores information input by health advisees and information input by doctors, dieticians, and sports instructors, in association with the health advisees' names (or user IDs).

A personal information database stores the health advisees' personal information such as their addresses, names, telephone numbers, and clinical histories.

The other-information database stores a reservation schedule for video conferences in association with doctor's names (or the names of medical institutions) and also stores information used for system management.

FIG. 3 shows the functions of the gateway program.

The gateway program has a meal delivery request accepting function 101, a food and nutrition data read and write function 102, a health consultation data read and write function 103, a health data read and write function 104, a communication recording function 105, a health consultation reservation accepting function 106, and a personal environment setting function 107.

The personal environment setting function 107 has a personal taste learning function 108, a security function 109, and a distribution condition setting function 110. Of the above mentioned functions, the functions 101 to 104 and 106 have been referred to in the description of the system in FIGS. 1 and 2, so that detailed description thereof will not be required.

The communication recording function 105 stores, in the form of communication logs, the user IDs of clients that have accessed the home page, the times at which the clients accessed the home page, and what pages the clients accessed. The personal taste learning function 108 learns pages on the home page which are frequently used by the user of each of the clients 10 to 40, and automatically arranges the buttons used to access the frequently used pages, at the top of the display screen. The personal taste learning function 108 is executed in connection with functions of XML documents or the like.

The security function 109 receives a user ID and a password from a client that accesses the server, and collates them. If the user ID and password match those stored in the other-information database in FIG. 2, the client is permitted to browse the home page.

The distribution condition setting function 110 is used to set a method for distributing information to a health advisee, dietician, or doctor. In this embodiment, the distribution method may be selected from a pager, a display on the browser, or an electronic mail. In the above description, the health advisee uses the browser to display, on the client 10, advice on the advisee's health consultation, while the server 50 distributes a message to the doctor by electronic mail, the message indicating that a permissible value is exceeded.

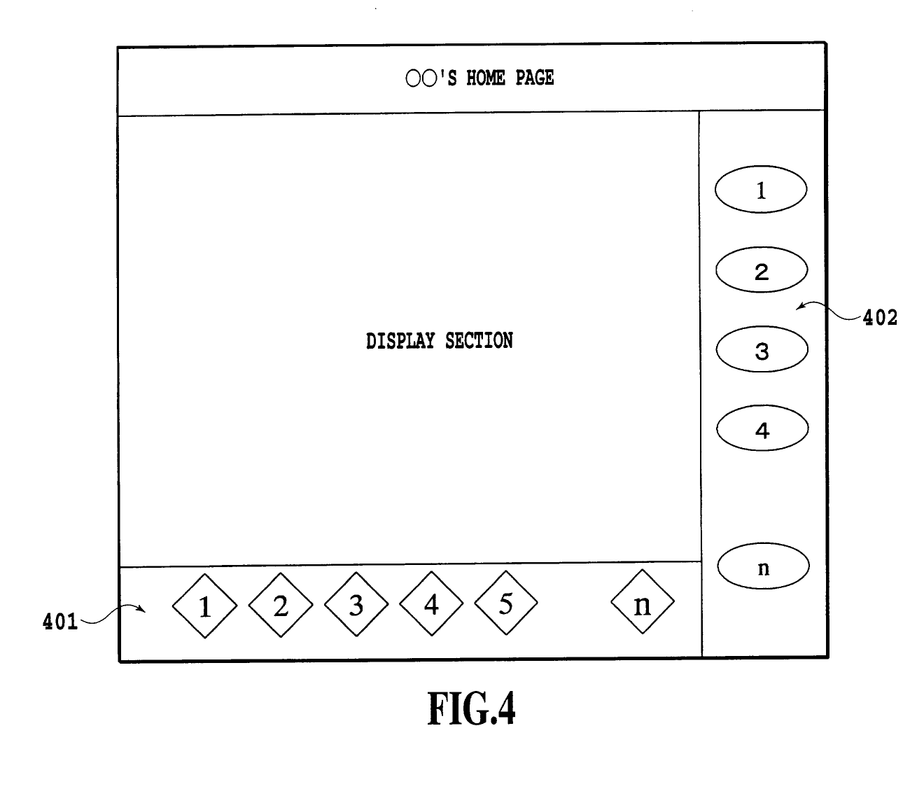

Typical information display screens and information input screens displayed using the browser will be described with reference to FIGS. 4 to 19. Documents on which these display screens are based are described in an HTML language or an XML language, which is an extension of the HTML language. Documents described in these languages contain strings for display and commands called “tags”. Tags include commands to read out images, commands to set the size and font of strings for display, and commands called “buttons” which cause transfers to other documents (pages) when operated by a mouse on the display screen.

The browser identifies the types of tags described in a document, and according to the instructions of the tags, synthesizes images to be displayed on the display screen or transmits commands to the server 50. These tags are well known, and it is possible for those skilled in the art to create a document for the home page on the basis of the description of FIGS. 4 to 19.

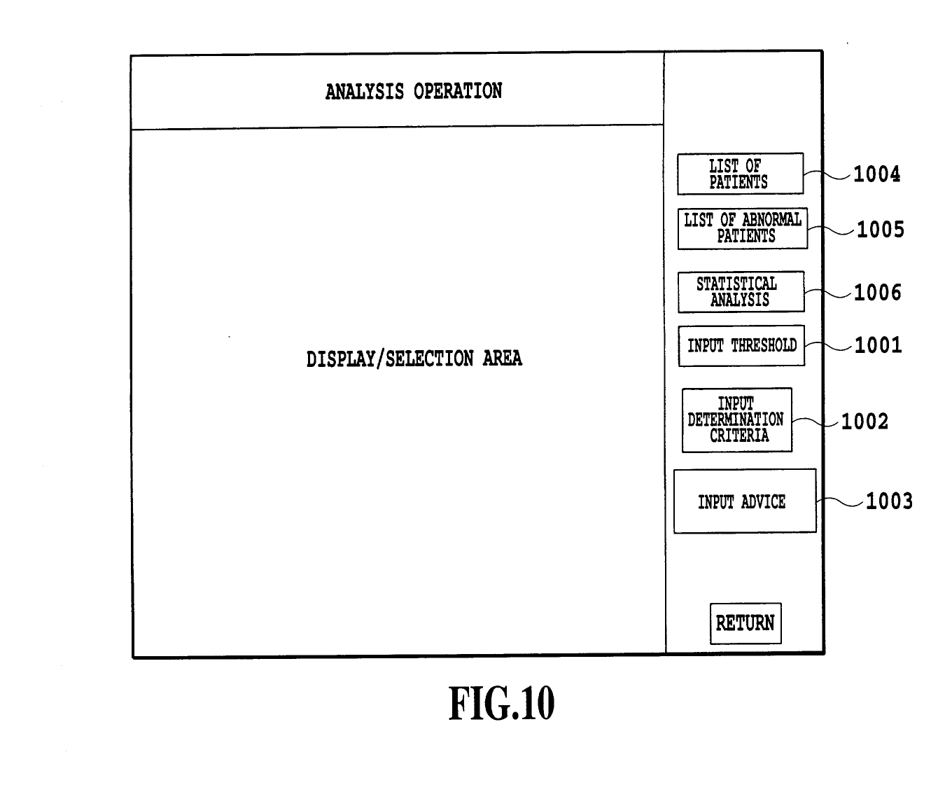

FIG. 4 shows the first screen displayed after the health advisee's client 10 has logged in the server 50 (password collation). In FIG. 10, advice information from the doctor, dietician, and sports instructor is displayed in the middle of the screen, function buttons 401 used to input information are shown at the bottom thereof, and a group of buttons 402 used to display various pieces of information are shown in the right thereof.

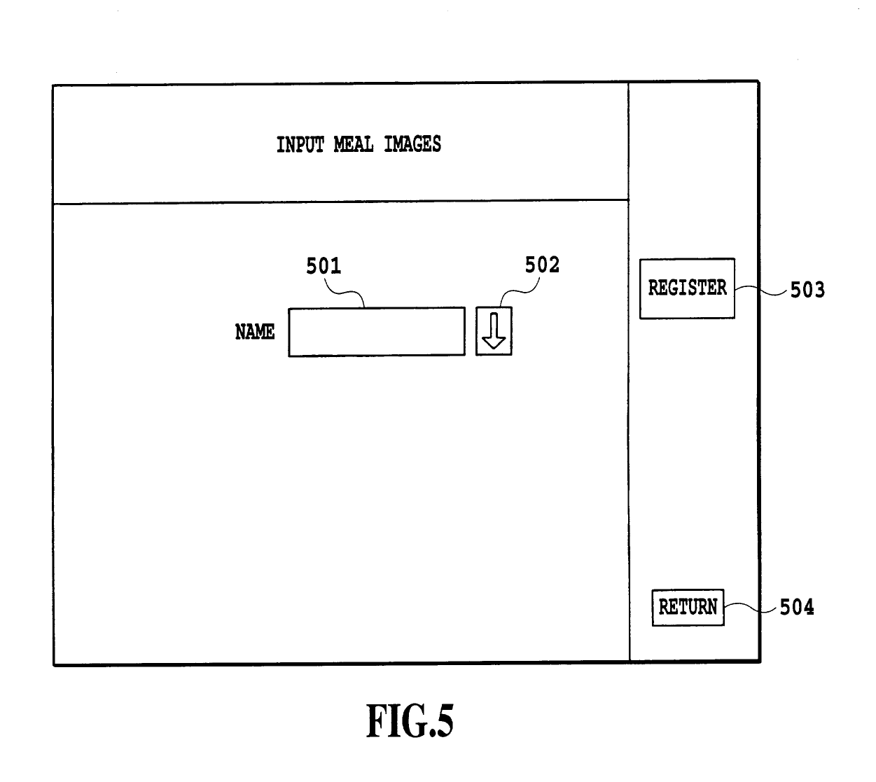

FIG. 5 shows a screen to which the screen in FIG. 4 is shifted when one of the group of function buttons 401 is operated and from which images of the foods of meals are input. The health advisee stores images of his or her daily foods previously photographed with a digital camera, in a predetermined hard disk storage area (called a “holder”) of the client 10.

The health advisee enters his or her name in an entry section 501 via the keyboard. In this case, in order to allow a plurality of health advisees to share one client, if a plurality of names are entered in this section, they are saved in the client so that a user selection button 502 can be used to select any of the saved names and that the selected names can then be entered in a selected user entry section 501. For this purpose, a tag in a document which serves to display this screen is defined.

Reference numeral 503 denotes a transmission start button. When the health advisee operates this button using the mouse, the photographed images previously stored in the holder and the user name entered in the selected user entry section 501 are transmitted to the server 50.

The server 50 stores the transmitted images in a storage area in the health care database which corresponds to the user name.

Reference numeral 504 denotes a return button. When this button is operated, the display screen returns to the one shown in FIG. 4.

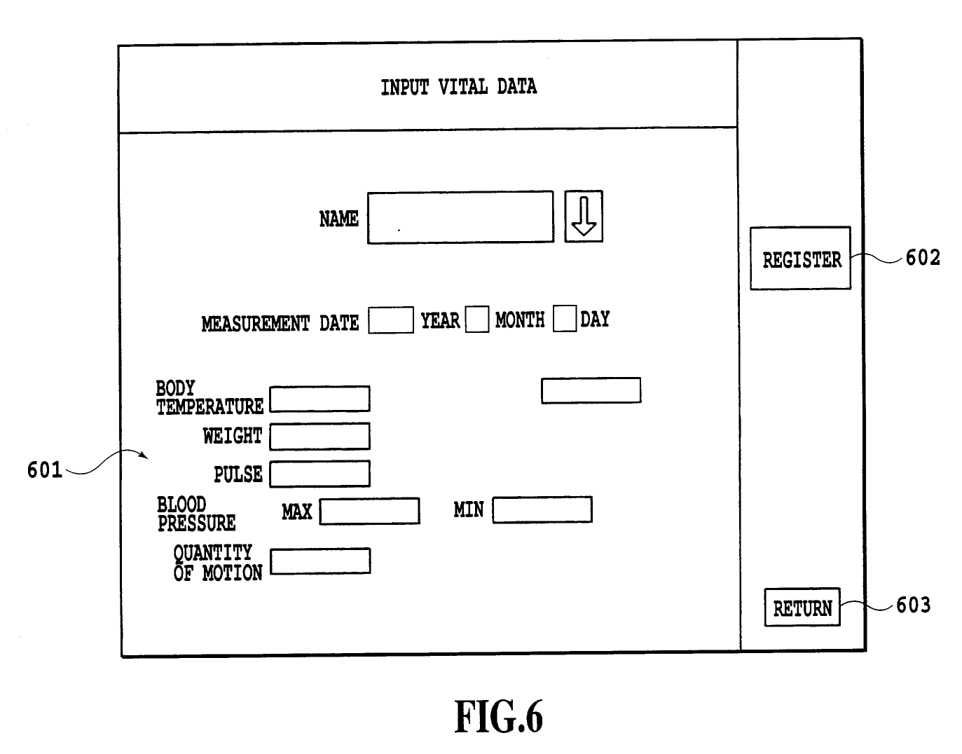

FIG. 6 is a vital data input screen. This screen is displayed by operating the corresponding one of the function buttons in FIG. 4. In this embodiment, elements such as blood pressure, body temperature, weight, pulse, electrocardiogram, blood sugar, and quantity of motion are specified as data indicative of the health state of the health advisee. The values for these elements are collectively called “vital data”. Reference numeral 601 denotes an entry section to which the vital data is input. Reference numeral 602 denotes a button used to instruct the entered vital data to be registered in the server 50. Reference numeral 603 denotes a button used to instruct the display screen to return to the one shown in FIG. 4.

The data input in this screen is transmitted to the server 50, where it is stored in the health care database. As described above, each data is compared with the corresponding permissible value by the gateway program of the server 50, and if the data exceeds the permissible value, the appropriate message is communicated to the doctor's client in the hospital. The communication method may be selected from a pager, an electronic mail, and a notice on the home page as determined by previously set conditions, as described above. The health advisee can also receive a notice by a distribution method selected by the health advisee, the notice indicating that any vital data exceeds the corresponding permissible value.

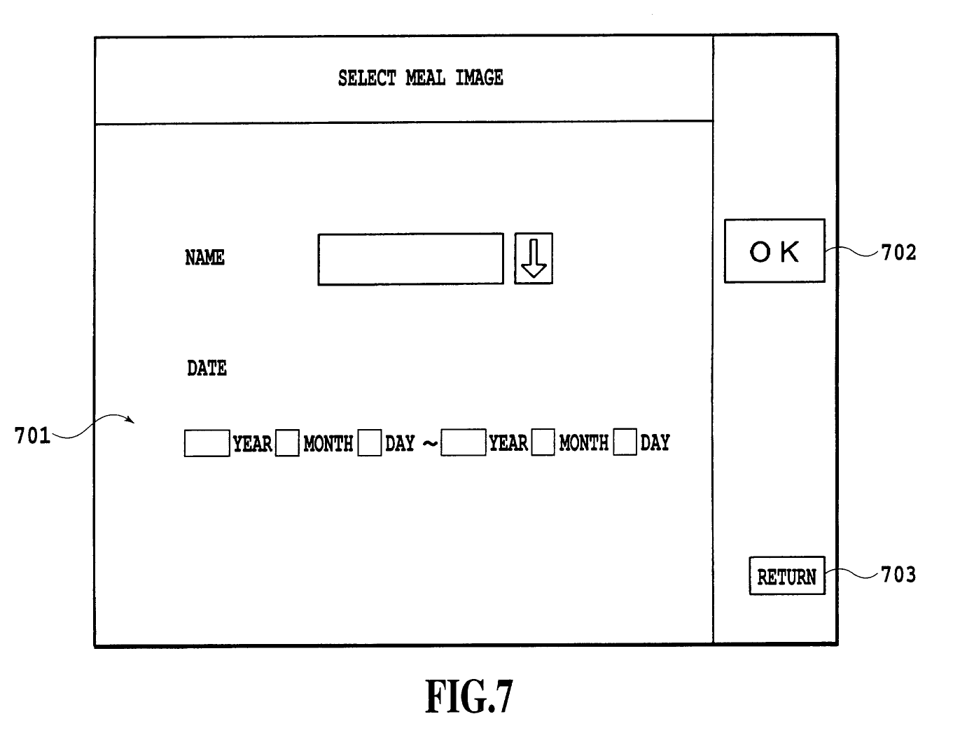

FIG. 7 shows a screen that allows the health advisee, dietician, or doctor to redisplay the images of the meals registered in the health care database. This screen is displayed by operating the corresponding one of the function buttons in FIG. 4.

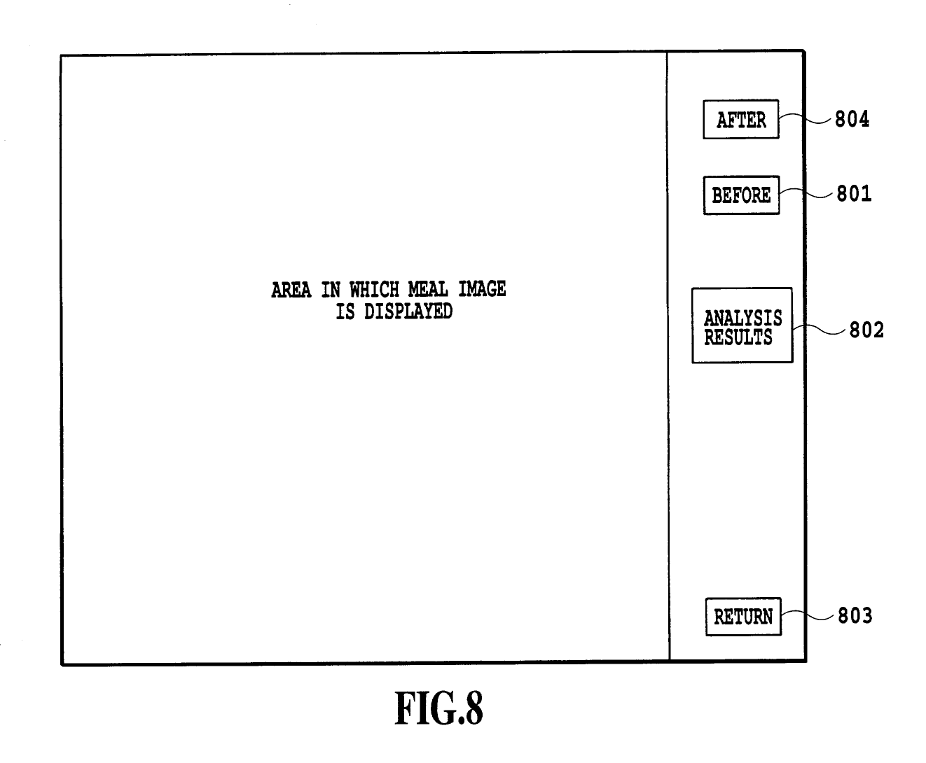

In FIG. 7, when an operator inputs a selected user name and a save date and time to an entry section 701 and operates a start button 702 using the mouse, the input selected user name and save time and date and a retrieval command are transmitted from the client to the server 50. In response to the retrieval command, the gateway program of the server 50 extracts the photographed image corresponding to the selected user name and save time and date and transmits the image to the requesting client. The transmitted photographed image is displayed on the display screen in FIG. 8. Reference numeral 703 denotes a button used to instruct to select the display screen in FIG. 4.

On the screen in FIG. 8, reference numeral 801 denotes a button used to instruct a display of the photograph of the meal preceding to the current one. Reference numeral 802 denotes a button used to instruct a shift to a meal analysis display screen. Reference numeral 803 denotes a button used to instruct a return to the screen in FIG. 8. Reference numeral 804 denotes a button used to instruct a display of the photograph of the image following the current one.

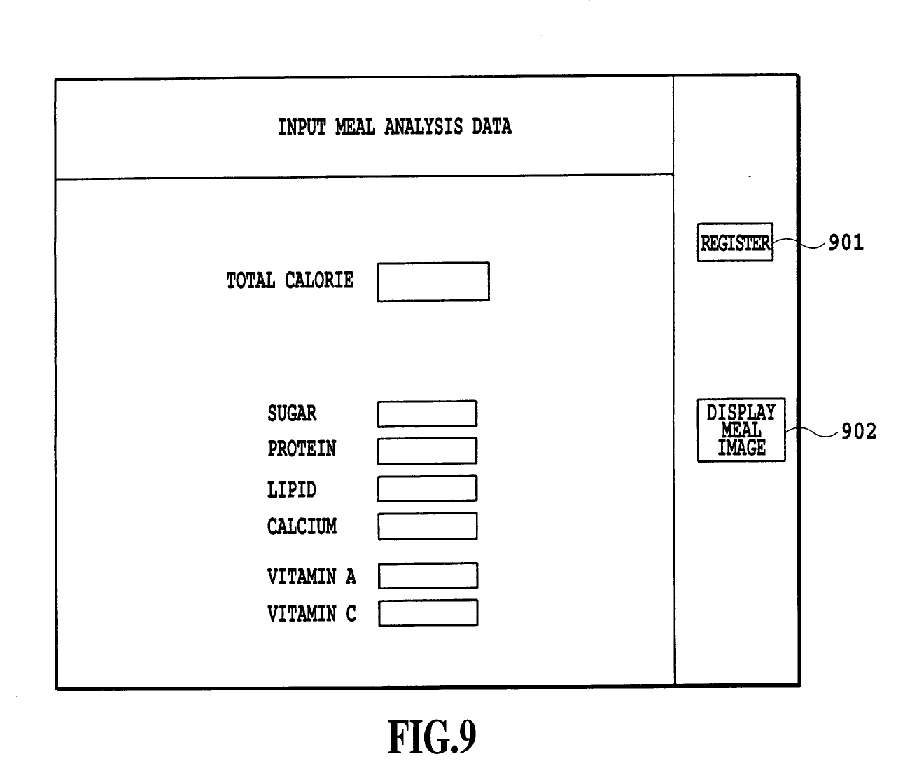

FIG. 9 shows a screen which is selected by operating the corresponding one of the function buttons in FIG. 4. This screen is used by the dietician and health advisee.

On this screen, the dietician and health advisee inputs data obtained by analyzing the photographed images of the meals. When a registration button 901 is operated by the dietician or health advisee, the input data is saved in the health care database in association with the health advisee's name. Reference numeral 902 denotes a button used to instruct a shift to the display screen in FIG. 8. The health advisee can analyze his or her meals, input the data, and compare it with the results of the dietician's analysis, thereby improving his or her analysis ability.

FIG. 10 shows the initial screen on which the doctor carries out health analysis and which the is selected by operating the corresponding one of the functions in FIG. 4.

When a patient list display button is operated, a list of patients is displayed. When the doctor selects from the list the name of a health advisee to be subjected to health analysis and then operates one of the buttons 1001 to 1006 (excluding 1004) depending on a certain purpose, the screen corresponding to the button as described later appears. The button 1001 is used to shift to a screen on which thresholds (permissible values) are set which are compared with vital data input by the health advisee, the results of analysis of the meals input by the dietician, or a combination thereof.

Reference numeral 1002 denotes the button used to shift to a screen on which logical conditions are set which are required to compare the vital data or the results of analysis of the meals with the corresponding thresholds.

Reference numeral 1003 denotes the button used to shift to a screen on which advice for the health advisee is input.

Reference numeral 1005 denotes the button used to instruct a shift to a screen that lists only health advisees whose vital data exceeds the corresponding threshold.

Reference numeral 1006 denotes the button used to shift to a screen used to instruct a statistical analysis process.

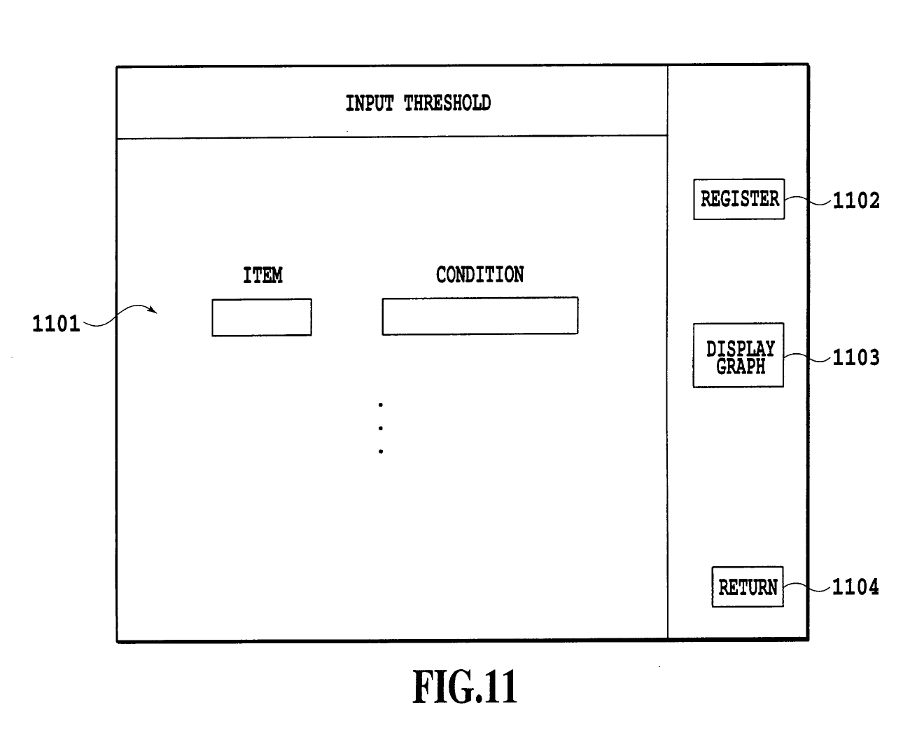

FIG. 11 shows a screen displayed by operating the button 1001 in FIG. 10. In FIG. 11, reference numeral 1101 denotes an input screen to which thresholds are input correspondingly to health care items (types of vital data). Reference numeral 1102 denotes a button used to instruct the input thresholds to be registered so that in response to an operation of this button, input data is transmitted from the doctor's client to the server 50, where it is registered in the health care database.

Reference numeral 1103 denotes the button used to instruct a graphical display of vital data accumulated for the past specified period. Reference numeral 1104 denotes a screen used to instruct a return to the screen in FIG. 10.

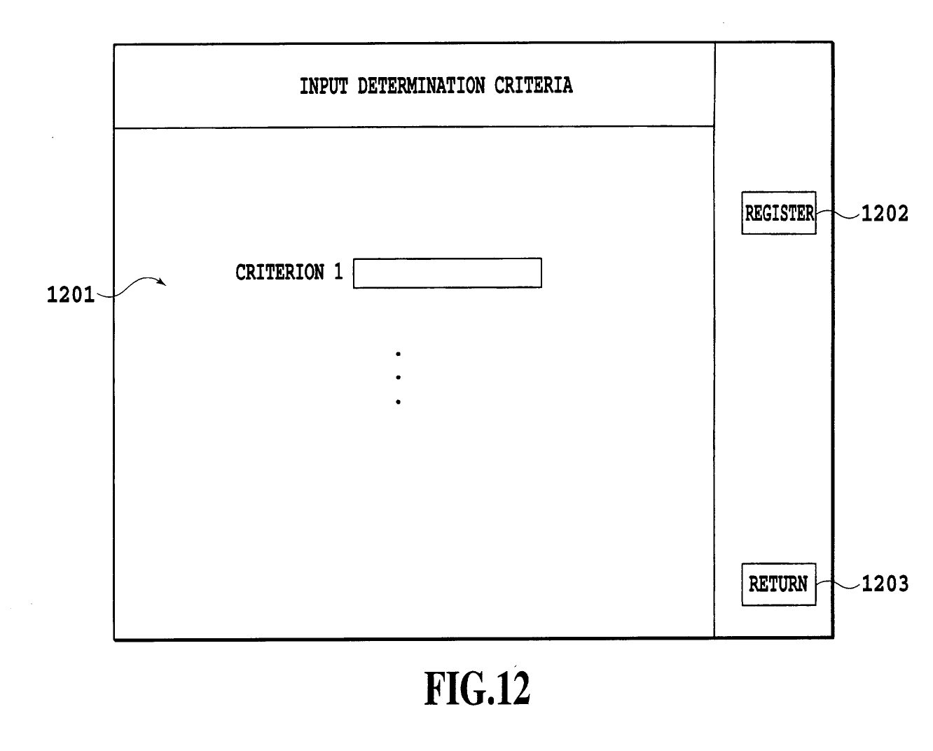

FIG. 12 shows a screen displayed by operating the button 1102 in FIG. 10. In FIG. 12, reference numeral 1201 denotes an input used to enter logical expressions that defines conditions for comparison between the thresholds and vital data, for example, a difference in magnitude, or combinations of vital data. Reference numeral 1202 denotes a button used to instruct the logical expressions input from the input section to be registered in the health care database. Thus, in this embodiment, discriminants (containing the thresholds) used to determine whether each health advisee is healthy or abnormal are variably set for each health advisee, thereby enabling a diagnosis suitable for the health advisee. Reference numeral 1203 denotes a screen used to instruct a return to the screen in FIG. 10.

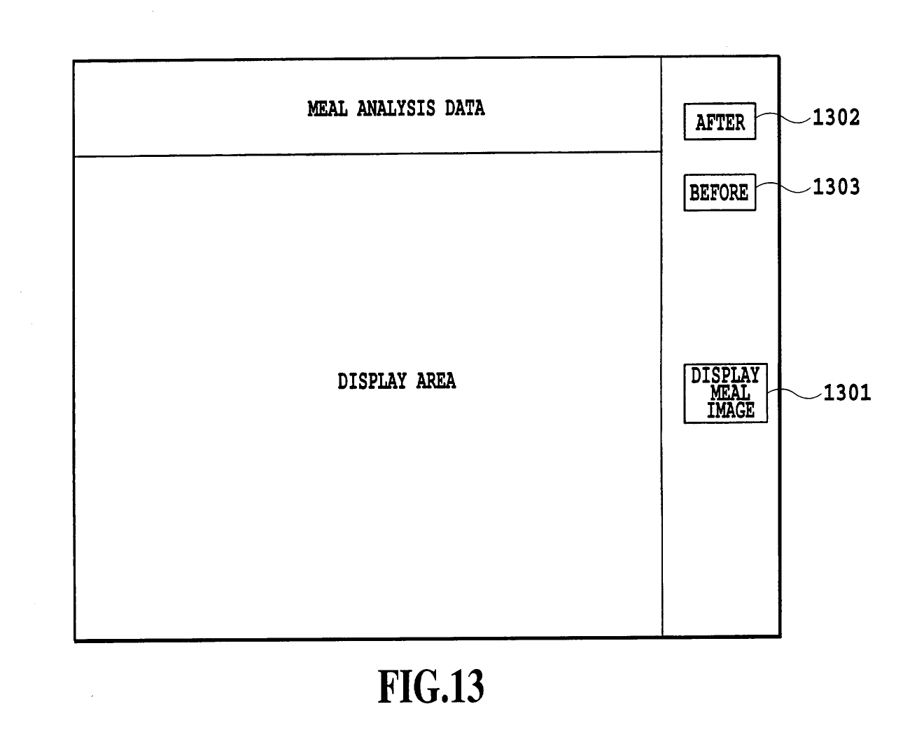

FIG. 13 is a screen which is selected by operating a meal analysis button 802 in FIG. 8. In response to an operation of the meal analysis button 802, a command to read out meal analysis data input on the screen in FIG. 9 and the name of the health advisee are transmitted from the operator's client, that is, one of the clients 10, 20, and 30 to the server 50. The gateway program of the server 50 reads out the corresponding data from the health care database and sends it back to the requesting client. The client displays the received meal analysis data. In FIG. 13, reference numeral 1301 denotes a button used to instruct a shift to a meal image screen. Reference numeral 1302 denotes a button used to instruct a display of the results of analysis of the meal following the current one. Reference numeral 1303 denotes a button used to instruct a display of the results of analysis of the meal preceding the current one.

Further, for comparison, the health advisee can display, on the same screen, the results of analysis of the images of the advisee's meals, previously input by himself or herself, and the results of the dietician's analysis of the same meals, read out from the server 50.

Furthermore, the health advisee can store, in the server 50, differences between the results of analysis of the images of the advisee's meals, previously input by himself or herself, and the results of the dietician's analysis so that the medical staff can check how the health advisee has learned self management.

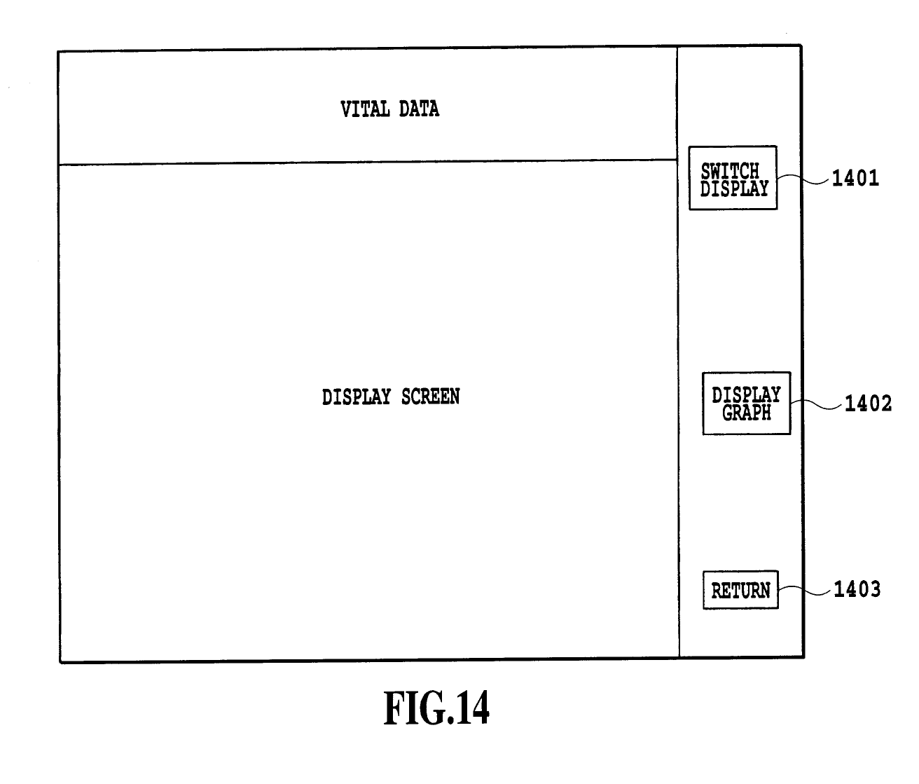

FIG. 14 shows a vital data display screen associated with a button on a screen (not shown) and displayed by operating this button. In response to an operation of this button, the name of the health advisee and a command to retrieve the latest vital data are transmitted from the client to the server 50, and the vital data read out from the server 50 is returned to the client. In FIG. 14, reference numeral 1401 denotes a button used to instruct a switch between a plurality of displays of the vital data. Reference numeral 1402 denotes a button used to instruct a graphical display, and reference numeral 1403, a button used to instruct the display to be ended. This screen is used by the health advisee and the doctor.

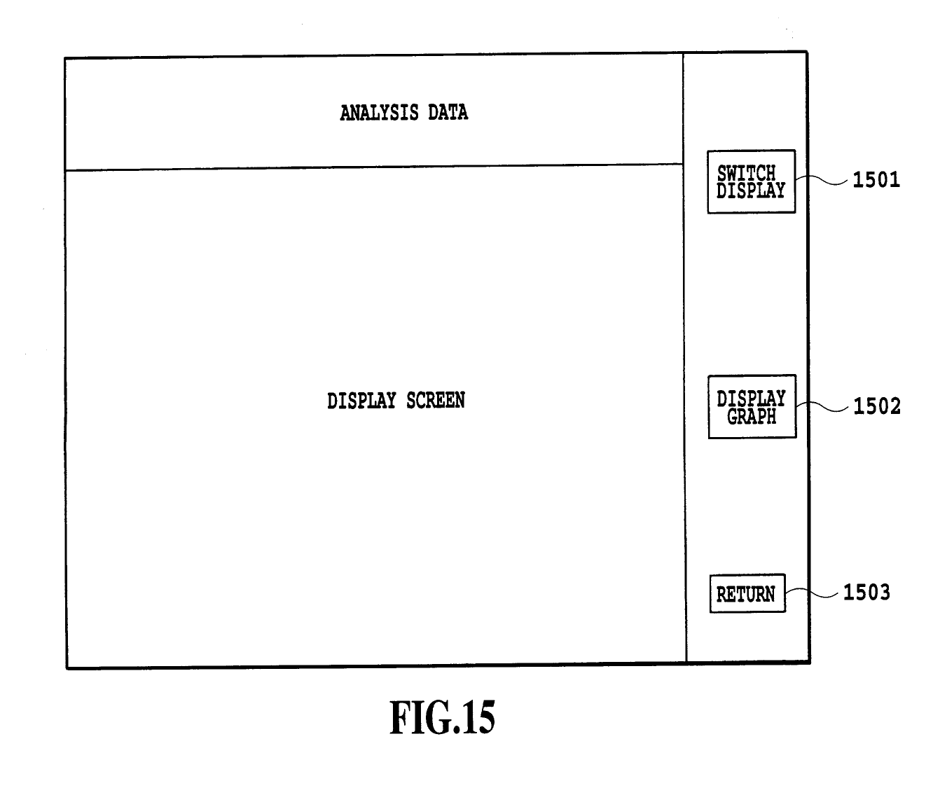

FIG. 15 is a display screen associated with a button on a screen (not shown) and displayed by operating this button. This screen is used only by the doctor. Operating the button causes a display of health analysis data (the doctor's case record information and vital data and the results of health analysis obtained on the basis of the results of analysis of the meals) registered in the health care database. Reference numeral 1501 denotes a button used to instruct a switch between a plurality of displays of the health analysis data. Reference numeral 1502 denotes a button used to instruct a graphical display, and reference numeral 1503, a button used to instruct the display to be ended.

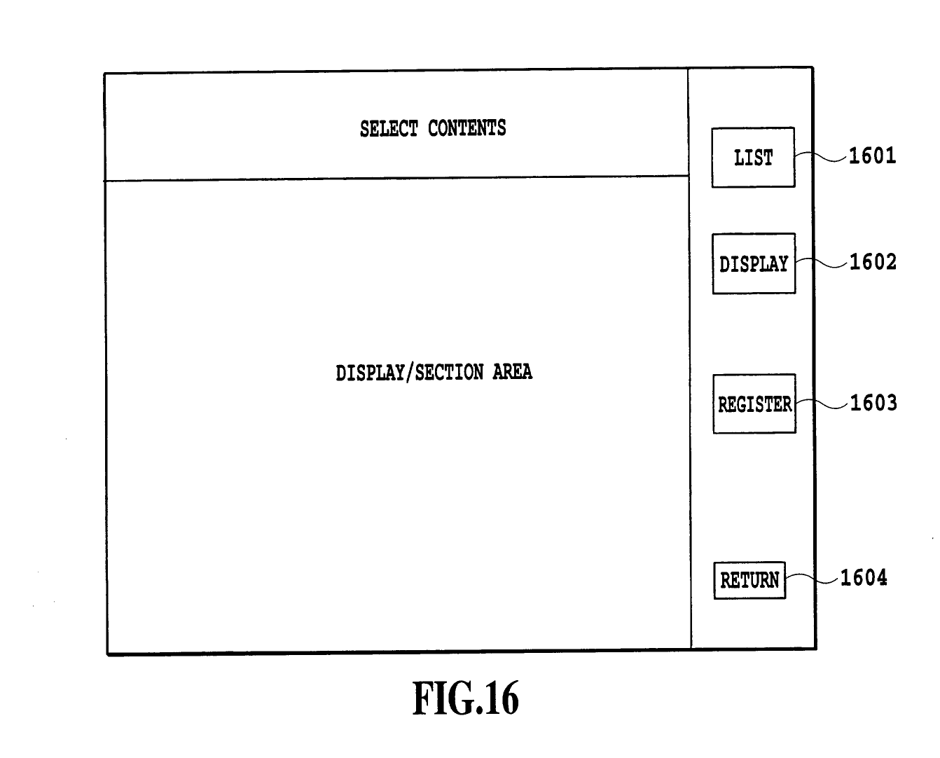

FIG. 16 shows one of a plurality of health advice input screens which is selected by operating the button 1003 in FIG. 10. On this screen the doctor inputs health advice for the health advisee. The advice is created not only by entering messages but also by attaching information such as illustrations, graphs, or animated images (this information is called “contents). The created advice information is transmitted from the doctor's client 20 to the server 50, where it is registered in the health management database. The registered advice is read out by and displayed on the health advisee's client 10 as described above. Reference numeral 1601 denotes a button used to instruct a display of a list of already created contents. Reference numeral 1602 denotes a button used to instruct a selected content to be displayed. Reference numeral 1603 denotes a button used to instruct the displayed content to be registered. Reference numeral 1604 denotes a button used to instruct a return to FIG. 10.

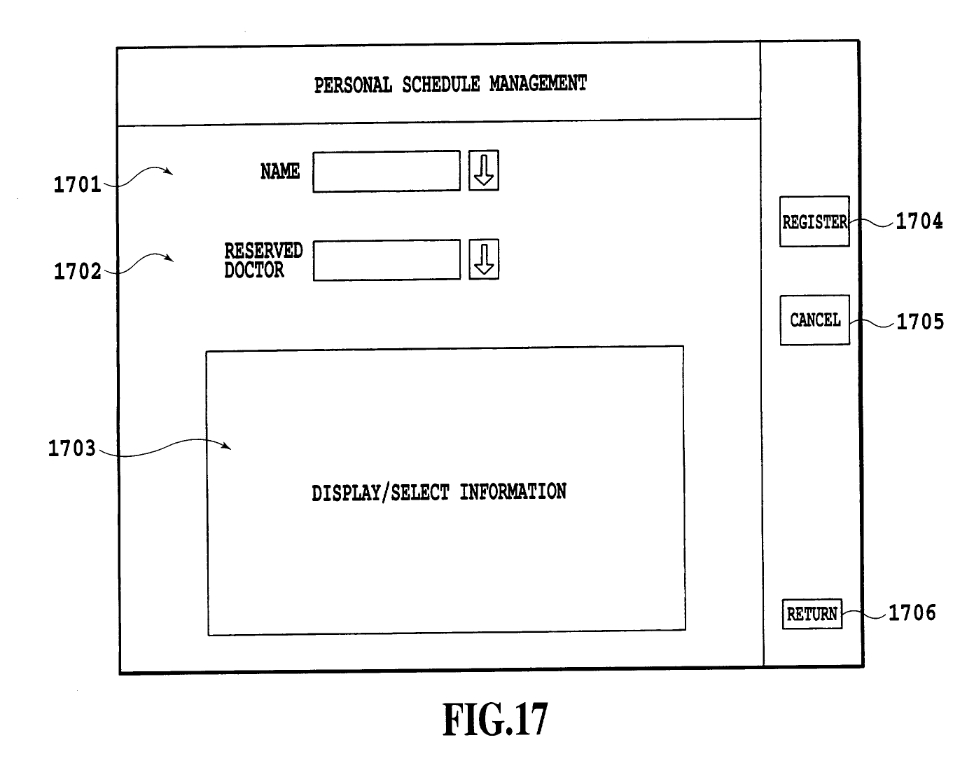

FIG. 17 shows a screen on which an online video conference, described above, is reserved. This screen is displayed by operating the corresponding one of the function buttons in FIG. 4. This screen is used by the health advisee. Reference numeral 1701 denotes a section in which the health advisee enters his or her name. A schedule information display selecting section 1703 displays a calendar so that a date and time to be reserved for a video conference is appointed by specifying a predetermined date in this section. Reference numeral 1702 denotes a section in which the name of the doctor or medical institution (consulting department) is entered. When the name of the medical institution or doctor and the desired reserved date are input, a display showing free time zones appears, and then the health advisee reserves the date and time by specifying it in this display. Operating a registration button 1704 causes the reserved date and time to be registered in the other-information database. In this respect, on the basis of a schedule registered by the doctor, the server 50 notifies the health advisee of dates and times available for reservations and those unavailable. The health advisee can cancel the reservation using a cancel button 1705 and return to the screen in FIG. 4 using a return button 1706.

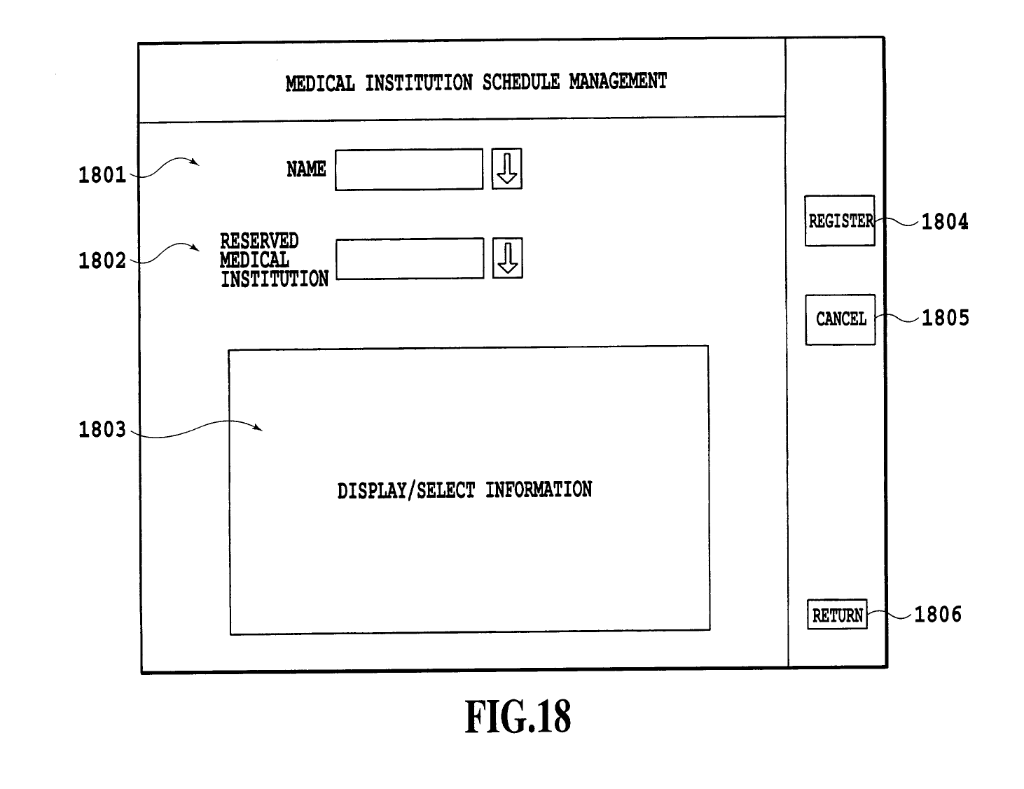

FIG. 18 shows a schedule coordinating screen displayed on the doctor's client by operating the corresponding one of the function buttons in FIG. 4. In FIG. 4, reference numeral 1801 denotes a section to which the name of the medical staff is input. Reference numeral 1802 denotes a section to which the name of the doctor, consulting department, or medical institution which needs to input a schedule is selected and input. Reference numeral 1803 denotes an area in which the schedule of the selected item is displayed. When the medical staff operates a registration button 1804, the appointed date and time are transmitted from the client 20 to the server 50, where it is registered in the other-information database. The medical staff can cancel the input reservation using a cancel button 1805. When the health advisee makes a reservation using a health consultation reservation accepting and browsing function of the gateway program, the unavailable dates and times are transmitted from the other-information database to the health advisee's client 10.

Further, the health advisee's reserved date and time registered in the other-information database of the server 50 is transmitted to the doctor's client and displayed in a schedule information display selecting section 1803 in FIG. 18. In this manner, the schedule is coordinated between the doctor and the health advisee so that on the reserved day, a video conference can be executed directly between the health advisee's client 10 and the doctor's client 20 using a video telephone program. The video telephone is well known, and detailed description thereof is thus unnecessary. A return button 1806 can be used to return to the screen in FIG. 4.

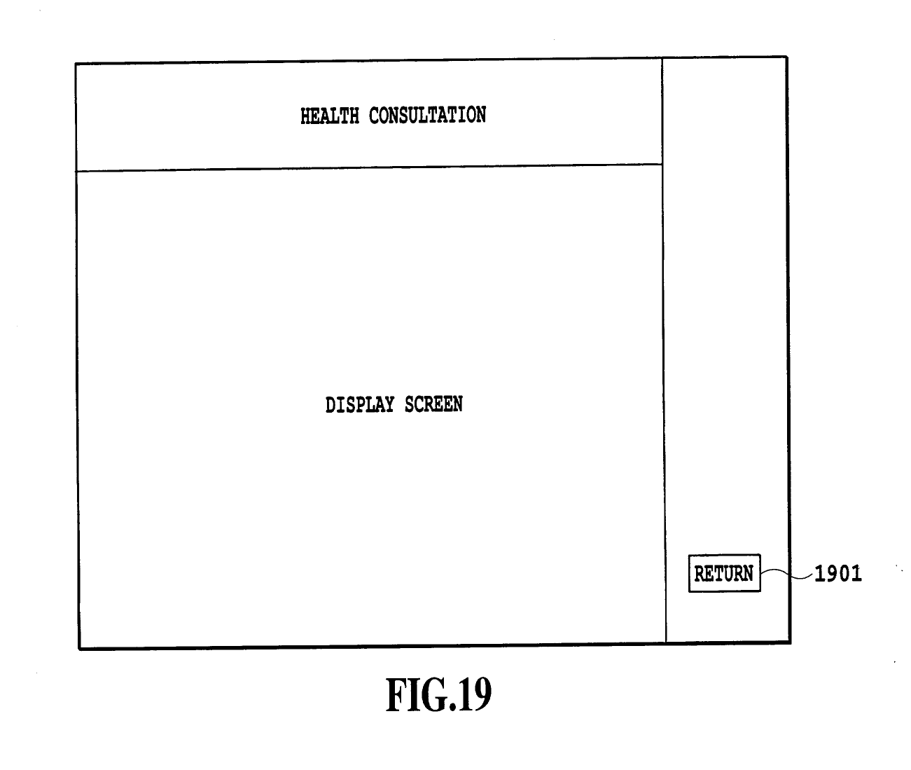

FIG. 19 shows a screen for electronic health consultations using the video telephone and displayed by operating the corresponding one of the function buttons in FIG. 4. After the conference has been completed, the return button can be used to return to the screen in FIG. 4.

In addition to the above described display screens, a screen appears which is used to request a delivery of a meal by operating the corresponding one of the function buttons in FIG. 4. When using this screen, foods for the meal are selected and destination information is input, the selected meal name and the destination information are transferred directly to the client 40 or via the server 50. The meal delivery service provider delivers the meal to the health advisee on the basis of the transferred information (the name of the meal or the names of the ingredients). The health advisee's client 10 may transfer the information to the delivery service provider's client 40 by electronic mail or via the other-information database of the server 50.

As described above, in this embodiment, the following can be achieved:

(1) The dietician analyzes electronic images of meals stored by the health advisee.

(2) The health advisee learns how to analyze meals by comparing the advisee's own analysis of means with the dietician's analysis of the same meals.

(3) The server 50 automatically checks vital data stored by the health advisee and the results of analysis of electronic images of the health advisee's meals stored by the dietician, and communicates these data to the health advisee and the doctor.

(4) The doctor sets determination rules and criteria for the automatic health check for each health advisee.

(5) A reservation schedule is coordinated between the doctor and the dietician and the health advisee so that on the basis of this schedule, a health consultation can be carried out using the video telephone.

(6) If the health advisee is determined to be abnormal as a result of the process in (4) and if it is determined as a result of the video conference that advice should be transmitted to the health advisee, then the medical staff transmits the appropriate advice to the health advisee.

Thus, the health advisee can receive the appropriate health advice, and the doctor needs to transmit advice to the health advisee only when required, and thus has an increased amount of time available for treatment operations in the hospital.

Furthermore, in this embodiment, the health advisee can request meals to be delivered to the advisee's home. This is very convenient to those health advisees who cannot go out. Further, the health advisee can receive meals or ingredients ordered directly with the delivery service provider by the dietician to maintain and improve the advisee's health state according to the expert's guidance.

Further, the present invention can implement the following embodiments:

1) In the above embodiment, the dietician or doctor consulted by the health advisee is notified of the health advisee's name by a system administrator by phone or electronic mail. However, by providing the server 50 with a table containing the correspondences between health advisees' user IDs and dieticians' and doctors' user IDs, the information communication between the dietician's client and the doctor's client can be automated, thereby simplifying operations that must be performed by each person.

For example, when the dietician is to display images of meals transmitted by the health advisee, on the dietician's client, the dietician must specify this health advisee's name using the list of health advisees. However, with the above mentioned correspondence table, the dietician can cause an automatic transmission of only the images transmitted from those health advisees who are assigned to the dietician and is thus released from operations required to read out the images. Further, since the images transmitted from those health advisees who are not assigned to the dietician are not displayed, the privacy of the health advisees is guarded.

2) In the above described embodiment, the direct communication between the health advisee and the doctor is carried out over the video telephone. However, of course, voice mails or normal telephones may be used for communication.

3) The above described display screens are only examples for description, and the arrangements or shapes of the buttons and the arrangements or sizes of the display areas are not limited.

4) In the above described embodiment, a notice of or advice on the results of analysis of meals from the dietician to the doctor or health advisee is displayed on the home page. However, such a notice can be given by electronic mail or displayed directly on the client or the health advisee's communication equipment using a well-known communication method. For example, a telephone, facsimile terminal equipment, or an electronic mail may be used. Further, a direct notice from the server may be given by phone, facsimile, or electronic mail. Furthermore, the doctor may give advice directly to the health advisee, and this communication may be carried out using a method other than the Internet.

5) In the above described embodiment, a health consultation is reserved over the video telephone. However, it should be appreciated that a health consultation may be reserved by phone or any of the other remote communication methods.

6) The medical staff, as used herein, refers to those who are engaged in health care including a doctor, a nurse, a dietician, and a sports therapist (including a sports instructor). Further, the health advisee, as used herein, refers to the health advisee as well as his or her family members and other related people. The client, as used herein, may be any information processing equipment having communication functions, including, for example, a personal computer, a workstation, and a television with an Internet connection function. The network, as used herein, includes a LAN, a WAN, a VAN, a public telephone network, a CATV network, and any other networks. When the client is to be connected to the server, this connection may be established via a network connection company such as a provider. Further, the predetermined people involved in notices include not only the health advisee and doctor but also the health advisee's family members, doctors of emergency medical institutions, and other related people.

7) Readout of vital data, electronic images of meals, and the results of analysis thereof is limited to the health advisee and his or her family members, doctors of emergency medical institutions, and other related people. The readout may be limited using a normal method such as the user ID and password.

Many variations other than the above described embodiments are possible. However, these variations fall within the technical scope of the present invention as long as they are based on the technical concepts described in the claims.

### INDUSTRIAL APPLICABILITY

According to the present invention, the dietician can give health advice online, thereby reducing a burden on the doctor. Further, the doctor can obtain the results of analysis of meals from the dietician and thus reference them when giving advice to the health advisee. Furthermore, the doctor can compare his or her own analysis of the meals with the dietician's analysis to improve his or her meal analysis ability.

Moreover, according to the present invention, advice from the dietician is transferred to the health advisee online so that the health advisee can consult with the dietician on the advisee's health at home. Furthermore, since previously registered photographed images of meals are saved in the server, the health advisee can check the photographed images of the meals at any time.

Further, according to the present invention, since the server automatically executes health examinations on the basis of vital data, the burden on the doctor is reduced. The discriminates for abnormality are set for each health advisee by the doctor, thereby enabling appropriate health examinations.

Furthermore, according to the present invention, if the health advisee is determined to be abnormal, one of the plurality of communication methods can be selected which is suitable for the doctor.

Moreover, according to the present invention, the doctor can transmit advice to the health advisee, and in this case, the doctor can reference the vital data saved in the server. Further, a schedule for a health consultation can be remotely coordinated between the health advisee and the doctor, thereby eliminating the need for the health advisee to visit the hospital until the advisee is instructed by the doctor to do so.

1. An electronic health consultation method for use in a health support including clients installed on a health advisee side and on a medical staff side and a server, the clients and the server being connected together via a network, the method comprising the steps of:
allowing the health advisee to store data about the advisee's health in the server via the advisee's client;
storing, in said server, results of analysis of the data about said health advisee's health stored in said server; and
allowing the data stored in said server to be shared via the client(s) of said health advisee and/or medical staff.

2. An electronic health consultation method according to claim 1, wherein said data about the health advisee's health is electronic images of said health advisee's meals, and said analysis results are data about nutritional analysis of the meals obtained by said medical staff by visually checking said electronic images of the meals.

3. An electronic health consultation method according to claim 2, wherein said health advisee can input his or her own nutritional analysis of the electronic images of said meals through the advisee's client, and the client can display both nutritional analysis data input by the health advisee and nutritional analysis data input by the medical staff.

4. An electronic health consultation method according to claim 3, wherein the nutritional analysis data input from said health advisee's client is transferred to and stored in the server, so that said server automatically compares the nutritional analysis data input by said medical staff's client and stored in said server with the nutritional analysis data input by the health advisee's client and stored in the server.

5. An electronic health consultation method according to claim 4, wherein the results of the comparison by said server is communicated to at least the health advisee's client.

6. An electronic health consultation method according to claim 2, wherein the electronic images stored in said server and advice on the results of the analysis are provided by said medical staff's client directly to said health advisee's client or via said server.

7. An electronic health consultation method according to claim 1, wherein the health advisee's vital data is input from said advisee's client and transferred to and stored in said server, and said server determines on the basis of a predetermined determination rule whether or not at least either the transferred vital data or the results of analysis of the meals are indicative of abnormality of the advisee's health, so that if a result of the determination indicates abnormality, this is communicated to a client of a predetermined related person, the client being connected to said network.

8. An electronic health consultation method according to claim 7, wherein settings of said determination rule used by said server can be changed for each health advisee by said medical staff's client.

9. An electronic health consultation method according to claim 7, wherein a communication method for notifying the related person's client that abnormality has been indicated can be chosen from a plurality of predetermined communication methods.

10. An electronic health consultation method according to claim 1, wherein a readout of the vital data stored in said server is limited.

11. An electronic health consultation method according to claim 1, wherein said medical staff includes a doctor and a dietitian, and said analysis data related to health can be input by each of the doctor's and dietitian's clients.

12. An electronic health consultation method according to claim 1, wherein said health advisee's client inputs a reservation for a health consultation with said medical staff, to said server, and said server notifies said medical staff's client of the input reservation.

13. An electronic health consultation method according to claim 12, wherein said medical staff's client can notify, via said server, said health advisee's client of health consultation dates and times that are inconvenient to the medical staff.

14. An electronic health consultation method according to claim 12, wherein advice on the health consultation between said medical staff and said health advisee can be transferred from said medical staff's client directly to said health advisee's client or via said server.

15. An electronic health consultation method according to claim 1, wherein said network has a meal delivery service provider's client connected thereto so that the health advisee's or medical staff's client can order a meal or ingredients via said server.

16. An electronic health consultation server for use in a health support system including clients installed on a health advisee side and on a medical staff side and a server, the clients and the server being connected together via a network, the server being characterized by comprising:
communication means for receiving data from an external client; and
storage means for storing the received data, and
wherein data about the health advisee's health received from the health advisee via the advisee's client and said communication means is stored in said storage means, results of analysis of the data about said health advisee's health are stored in said storage means, and the data stored in said storage means is shared via the client(s) of said health advisee and/or medical staff.

17. An electronic health consultation server according to claim 16, wherein said data about the health advisee's health is electronic images of said health advisee's meals, and said analysis results are data on nutritional analysis of the meals obtained by said medical staff by visually checking said electronic image of the meals.

18. An electronic health consultation server according to claim 17, wherein said health advisee can input his or her own nutritional analysis of the electronic images of said meals through the advisee's client, and the client can display both nutritional analysis data input by the health advisee and nutritional analysis data input by the medical staff.

19. An electronic health consultation server according to claim 18, characterized by further comprising comparison means for receiving the nutritional analysis data input from said health advisee's client, via said communication means, for storing the received nutritional analysis data in said storage means, and for automatically comparing the nutritional analysis data input by said medical staff's client and stored in said storage means with the nutritional analysis data input by the health advisee's client and stored in said storage means.

20. An electronic health consultation server according to claim 19, further comprising means for communicating results of the comparison by said comparison means to at least the health advisee's client.

21. An electronic health consultation server according to claim 17, wherein the electronic images stored in said storage means and advice on the results of the analysis are provided by said medical staff's client directly to said health advisee's client or via said server.

22. An electronic health consultation server according to claim 16, further comprising means for inputting the health advisee's vital data through said advisee's client, transferring the input vital data to said electronic health consultation server for storage, and determining on the basis of a predetermined determination rule whether or not at least either the transferred vital data or the results of analysis of the meals are indicative of abnormality of the advisee's health, and means for operating if a result of the determination indicates abnormality, to communicate this to a client of a predetermined related person, the client being connected to said network.

23. An electronic health consultation server according to claim 22, wherein settings of said determination rule used by said server can be changed for each health advisee by said medical staff's client.

24. An electronic health consultation server according to claim 22, wherein a communication method for notifying the related person's client that abnormality has been indicated can be chosen from a plurality of predetermined communication methods.

25. An electronic health consultation server according to claim 16, wherein a readout of the vital data stored in said storage means is limited.

26. An electronic health consultation server according to claim 16, wherein said medical staff includes a doctor and a dietitian, and said analysis data related to health can be input by each of the doctor's and dietitian's clients.

27. An electronic health consultation server according to claim 16, wherein a reservation for a health consultation with said medical staff is received from said health advisee's client via said communication means, and the received reservation is communicated to said medical staff's client via said communication means.

28. An electronic health consultation server according to claim 27, wherein said medical staff's client can notify, via said communication means, said health advisee's client of health consultation dates and times that are inconvenient to the medical staff.

29. An electronic health consultation server according to claim 27, wherein advice on the health consultation between said medical staff and said health advisee can be transferred from said medical staff's client directly to said health advisee's client or via said communication means.

30. An electronic health consultation server according to claim 16, wherein said network has a meal delivery service provider's client connected thereto so that the health advisee's or medical staff 's client can order a meal or ingredients via said communication means.

31. A health advisee client for use in a health support system, said system including clients installed on a health advisee side and on a medical staff side and a server, the clients and the server being connected together via a network, the health advisee client comprising:
input means for allowing data on health to be input; and
communication means for transmitting the data to said server, and
wherein the health advisee stores data about the advisee's health in said server via said input means and said communication means, stores, in said server, results of analysis of the data about said health advisee's health stored in said server, and shares the data stored in said server via the client(s) of said health advisee and/or medical staff.

32. A health advisee client according to claim 31, wherein said data about the health advisee's health is electronic images of said health advisee's meals, and said analysis results are data about nutritional analysis of the meals obtained by said medical staff by visually checking said electronic image data of the meals.

33. A health advisee client according to claim 32, wherein said health advisee can input his or her own nutritional analysis of the electronic images of said meals through the advisee's client, and the client comprises display means that can display both nutritional analysis data input by the health advisee and nutritional analysis data input by the medical staff.

34. A health advisee client according to claim 33, wherein the input nutritional analysis data is transferred via said communication means to said server for storage, said server automatically compares the nutritional analysis data input by said medical staff's client and stored in said storage means with the nutritional analysis data input by the health advisee's client and stored in said storage means.

35. A health advisee client according to claim 34, wherein results of the comparison by said server are communicated to the health advisee's client and received via said communication means.

36. A health advisee client according to claim 31, wherein the electronic images stored in said server and advice on the results of the analysis are provided by said medical staff's client directly to said health advisee's client or via said server.

37. A health advisee client according to claim 32, wherein the health advisee's vital data is input by said input means, the input vital data is transferred via said communication means to said server for storage, and it is determined on the basis of a predetermined determination rule whether or not at least either the transferred vital data or the results of analysis of the meals are indicative of abnormality of the advisee's health, so that if a result of the determination indicates abnormality, this is communicated to a client of a predetermined related person, the client being connected to said network, the health advisee's client receiving said determination results via said communication results.

38. A health advisee client according to claim 37, wherein settings of said determination rule used by said server can be changed for each health advisee by said medical staff's client.

39. A health advisee client according to claim 37, wherein a communication method for notifying the related person's client that abnormality has been indicated can be chosen from a plurality of predetermined communication methods.

40. A health advisee client according to claim 31, wherein readout of the vital data stored in said server means is limited.

41. A health advisee client according to claim 31, wherein said medical staff includes a doctor and a dietitian, and said analysis data related to health can be input by each of the doctor's and dietitian's clients.

42. A health advisee client according to claim 31, wherein said input means inputs a reservation for a health consultation with said medical staff to said server, and said server notifies said medical staff's client of the input reservation.

43. A health advisee client according to claim 42, wherein said medical staff's client can notify, via said server, said health advisee's client of health consultation dates and times that are inconvenient to the medical staff, and said dates and times can be received via said communication means.

44. A health advisee client according to claim 42, wherein said communication means receives advice on the health consultation between said medical staff and said health advisee directly from said medical staff's client or via said server using said communication means.

45. A health advisee client according to claim 31, wherein said network has a meal delivery service provider's client connected thereto so that the health advisee's or medical staff's client can order a meal or ingredients via said input means and communication means.

46. A medical staff client for use in a health support system said system including clients installed on a health advisee side and on a medical staff side and a server, the clients and the server being connected together via a network, the medical staff client comprising:
input means for inputting data; and
communication means for communicating the data to and from at least said server, and
wherein the health advisee stores data about the advisee's health in said server via the advisee's client, stores, in said server, results of analysis of the data about said health advisee's health stored in said server, and shares the data stored in said server via the client(s) of said health advisee and/or medical staff.

47. A medical staff client according to claim 46, wherein said data about the health advisee's health is electronic images of said health advisee's meals, the medical staff client further comprises display means for displaying said electronic image data of the meals, and said analysis results are data about nutritional analysis of the meals obtained by said medical staff by visually checking said electronic image data of the meals displayed on said display means.

48. A medical staff client according to claim 47, wherein said health advisee can input his or her own nutritional analysis of the electronic images of said meals through the advisee's client, and the client can use said display means to display both nutritional analysis data input by the health advisee and nutritional analysis data input by the medical staff.

49. A medical staff client according to claim 48, wherein the nutritional analysis data input by said health advisee's client is transferred to said server for storage, and said server automatically compares the nutritional analysis data input by said medical staff's client and stored in said storage means with the nutritional analysis data input by the health advisee's client and stored in said storage means.

50. A medical staff client according to claim 49, wherein results of the comparison by said server are communicated to at least the health advisee's client.

51. A medical staff client according to claim 47, wherein the electronic images stored in said server and advice on the results of the analysis are input through said input means and then provided directly to said health advisee's client or via said server using said communication means.

52. A medical staff client according to claim 46, wherein said health advisee's client inputs the health advisee's vital data, the input vital data is transferred to said server for storage, and it is determined on the basis of a predetermined determination rule whether or not at least either the transferred vital data or the results of analysis of the meals are indicative of abnormality of the advisee's health, so that if a result of the determination indicates abnormality, this is communicated to a client of a predetermined related person, the client being connected to said network, said determination results being received via said communication results.

53. A medical staff client according to claim 52, wherein settings of said determination rule used by said server can be changed for each health advisee by said medical staff's client.

54. A medical staff client according to claim 52, wherein a communication method for notifying the related person's client that abnormality has been indicated can be chosen from a plurality of predetermined communication methods.

55. A medical staff client according to claim 46, wherein readout of the vital data stored in said server means is limited.

56. A medical staff client according to claim 46, wherein said medical staff includes a doctor and a dietitian, and said analysis data related to health can be input through said input means.

57. A medical staff client according to claim 46, wherein said health advisee's client inputs a reservation for a health consultation with said medical staff to said server, and said server notifies said medical staff's client of the input reservation, said reservation being received via said communication means.

58. A medical staff client according to claim 57, wherein health consultation dates and times that are inconvenient to the medical staff can be communicated to said health advisee's client via said input means, said communication means, and said server.

59. A medical staff client according to claim 57, wherein advice on the health consultation between said medical staff and said health advisee can be input through said input means and transferred directly to said health advisee's client or via said server, using said communication means.

60. A medical staff client according to claim 46, wherein said network has a meal delivery service provider's client connected thereto so that the health advisee's or medical staff's client can order a meal or ingredients via said input means and communication means.
